(19) United States
(12) Patent Application Publication
(10) Pub. No.: US 2011/0061885 A1
(43) Pub. Date: Mar. 17, 2011

(54) SNAP-ON ONE-PIECE SCREWLESS COVER PLATE FOR ELECTRICAL FIXTURES

(76) Inventor: Leslie Dianne Wilson, Lilburn, GA (US)

(21) Appl. No.: 12/883,167

(22) Filed: Sep. 15, 2010

Related U.S. Application Data
(60) Provisional application No. 61/242,848, filed on Sep. 16, 2009.

(51) Int. Cl. H02G 3/14

(52) U.S. Cl. 174/66

(57) ABSTRACT

A snap-on, one-piece screwless cover plate for electrical fixtures is disclosed. The cover plate assembly includes a snap-on, one piece, screwless cover plate for an electrical receptacle box that is capable of being installed directly to an electrical device that is installed in the receptacle box. In various embodiments, the securing mechanism for the cover plate can be in the form of protrusions, prongs, or other structural members, each integrally formed with the cover plate. The protrusions, prongs, or other structural members integrally formed with the cover plate provide a means of attachment to any electrical device that is mounted into the receptacle box, including, but without limitation, an electrical outlet, light switch, oven plug, cable or phone connection, stereo, etc. and without alteration to the electrical device.

### CROSS-REFERENCE TO RELATED APPLICATION(S)

The present non-provisional patent application claims the benefit of priority of U.S. Provisional Patent Application No. 61/242,848, which is entitled “SNAP-ON SCREWLESS COVER PLATE FOR ELECTRICAL FIXTURES”, which was filed on Sep. 16, 2009, and which is incorporated in full by reference herein.

### FIELD OF THE INVENTION

The technology described herein relates generally to electrical wiring components, electrical devices, receptacle boxes, cover plates, and cover plate assemblies. More specifically, this technology relates to a snap-on, one-piece screwless cover plate for electrical devices.

### BACKGROUND OF THE INVENTION

Known receptacle box cover plates, or faceplates, are typically constructed in the form of a generally flat plate having one or more openings to provide access to a wired device, or the like, mounted in the receptacle box. The purpose of a cover plate is to provide a decorative cover for the receptacle box installation while also preventing operator exposure to the interior of the receptacle box, which in many instances contains electrical wiring. By way of example, a cover plate can cover a receptacle box containing devices such as ON/OFF switches, outlet receptacles, dimmers, motor speed selector switches, coaxial cable connectors, TV antenna connectors, telephone jacks, computer network cable connectors, informational devices such as clocks, thermometers, security systems, and so forth.

Related patents known in the background art include the following: U.S. Pat. No. D484,392, issued to Mayo et al. on Dec. 30, 2003, discloses the ornamental design for a screwless faceplate. Related patent application publications known in the background art include the following: U.S. Patent Application No, 2007/0123098, filed by Huang and published on May 31, 2007, discloses a screwless wall-plate.

### BRIEF SUMMARY OF THE INVENTION

In various exemplary embodiments, the technology described herein provides a snap-on, one-piece screwless cover plate to cover a receptacle box, such as, for example but not limited to, an electrical receptacle box for an electrical outlet.

In various embodiments, a snap-on, one-piece screwless cover plate for electrical devices is disclosed. The cover plate assembly includes a snap-on, one piece, screwless cover plate for a receptacle box that is capable of being installed directly to an electrical device that is installed in the receptacle box. In various embodiments, the securing mechanism for the cover plate can be in the form of protrusions, prongs, or other structural members (hereinafter referred to generally as “prongs”), each integrally formed with the cover plate. The prongs integrally formed with the cover plate provide a means of attachment to any electrical device that is mounted into the receptacle box, including, but without limitation, an electrical outlet, light switch, oven plug, cable or phone connection, stereo, etc.

In at least one embodiment, the snap-on, one-piece screwless cover plate includes prongs disposed on the cover plate in a manner in which the cover plate is secured to the electrical device in a center attachment area.

In at least one embodiment, the snap-on, one-piece screwless cover plate includes prongs disposed on the cover plate in a manner in which the cover plate is secured to the electrical device in a side attachment area.

In at least one embodiment, the snap-on, one-piece screwless cover plate includes prongs disposed on the cover plate in a manner in which the cover plate is secured to the electrical device in a center hole attachment area.

In at least one embodiment, the snap-on, one-piece screwless cover plate includes prongs disposed on the cover plate in a manner in which the cover plate is secured to the electrical device in an attachment area going into two existing holes of the electrical device, one located above and one located below the electrical device.

As will be apparent to one of ordinary skill in the art, after reading the disclosure contained herein, there are numerous optional configurations of the locations of the prongs and the shape or size of the prongs which can provide further options to accommodate various devices. Additionally, optional configurations can include 1-gang, 2-gang, 3-gang, and so forth, arrangements.

In at least one embodiment, the snap-on, one-piece screwless cover plate is manufactured of a biodegradable material.

In at least one embodiment, the snap-on, one-piece screwless cover plate is manufactured of an anti-bacterial material.

In at least one embodiment, the snap-on, one-piece screwless cover plate also includes an insulation portion in order to eliminate the need for separate foam insulation cutouts to go underneath a cover plate.

In at least one embodiment, the snap-on, one-piece screwless cover plate can be made of a plastic material having a coating that makes the cover plate to appear to be made of metal.

The type of plastic used in any of the embodiments can vary according to its end use. By way of example, the plastic can be nylon, ABS, etc., or any combination of more than one type of plastic.

In at least one embodiment, the snap-on, one-piece screwless cover plate also includes one or more support ribs, the location of which can vary according to the electrical device to which it is attached. Examples of such ribs are shown in the following figures labeled as reference numeral 26. The ribs also may be left off entirely if the strength of the plastic is determined to be sufficient.

Advantageously, the snap-on, one-piece screwless cover plate provides easy installation, without the use of tools, and sustained coverage of a receptacle box without the need for or use of screws, including those used in known devices through holes in the cover plate or in a separate device that intervenes between the electrical device and the cover plate. The latter such devices appear to be screwless on the face of the cover plate, but actually use screws on the intervening device to connect the intervening device to the electrical device. The technology disclosed herein uses no such intervening device. Additionally, utilizing a cover plate without screws ensures that no mismatch of color between screws and the cover plate exists.

Also advantageously, the snap-on, one-piece screwless cover plate provides a solution in which no new receptacle box is required. The snap-on, one-piece screwless cover plate can be distributed new with an electrical receptacle box assembly, an electrical device assembly, or, alternatively, can be distributed individually to be utilized upon an existing receptacle box. In each of the disclosed embodiments, the snap-on, one-piece screwless cover plate requires no modification by the manufacturer of the existing electrical devices or receptacle boxes to make them work.

Further advantageously, the snap-on, one-piece screwless cover plate provides a solution in which time, labor, and expenses are saved due to the ease of use and installation without screws and tools. Manufacturing and packaging costs are also lessened due to the elimination of the screws, painting of the screws, separate packaging of the screws, elimination of shipping of the screws to the cover plate manufacturer, and elimination of any intervening devices. Use of the snap-on, one-piece screwless cover plate also saves the environment with its use of fewer parts, less packaging, and the elimination of painting of the screws.

There has thus been outlined, rather broadly, the more important features of the technology in order that the detailed description thereof that follows may be better understood, and in order that the present contribution to the art may be better appreciated. There are additional features of the technology that will be described hereinafter and which will form the subject matter of the claims appended hereto. In this respect, before explaining at least one embodiment of the technology in detail, it is to be understood that the invention is not limited in its application to the details of construction and to the arrangements of, and the shape and size of, the components set forth in the following description or illustrated in the drawings. The technology described herein is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the technology described herein.

Further objects and advantages of the technology described herein will be apparent from the following detailed description of a presently preferred embodiment which is illustrated schematically in the accompanying drawings.

### BRIEF DESCRIPTION OF THE DRAWINGS

The technology described herein is illustrated with reference to the various drawings, in which like reference numbers denote like device components and/or method steps, respectively, and in which:

FIG. 1 is a front perspective view of a snap-on, one-piece screwless cover plate illustrating, in particular, a method of installation upon an electrical device that is installed in an electrical receptacle box, according to an embodiment of the technology described herein;

FIG. 2A is a front view of a snap-on, one-piece cover plate having a pair of prongs for a center attachment area, according to an embodiment of the technology described herein;

FIG. 2B is a rear view of the cover plate depicted in FIG. 2A;

FIG. 2C is a side view of the cover plate depicted in FIG. 2A;

FIG. 2D is a side cross-sectional view of the cover plate depicted in FIG. 2B;

FIG. 2E is a close-up, cross-sectional view of the prongs depicted in FIG. 2A, wherein the shape of the prong is not limited to the shape or size shown, but can vary according to need;

FIG. 3 is a perspective view of an electrical outlet, illustrating, in particular, the attachment area for the prongs depicted in FIGS. 2A-2E that utilize a friction fit, according to an embodiment of the technology described herein;

FIG. 4A is a front view of a snap-on, one-piece cover plate having a pair of prongs on each side of each outlet with a side attachment area, according to an embodiment of the technology described herein, wherein the location for attachment along the sides can be anywhere along the side of the electrical device, according to an embodiment of the technology described herein;

FIG. 4B is a rear view of the cover plate depicted in FIG. 4A;

FIG. 4C is a side cross-sectional view of the cover plate depicted in FIG. 4B;

FIG. 4D is a side view of the cover plate depicted in FIG. 4A;

FIG. 4E is a top, cross-sectional view of the cover plate depicted in FIG. 4A, wherein the shape of the prong is not limited to the shape or size shown, but can vary according to need;

FIG. 4F is a close-up, cross-sectional view of one of the prongs depicted in FIG. 4E, wherein the shape of the prong is not limited to the shape or size shown, but can vary according to need;

FIG. 5 is a perspective view of an electrical outlet, illustrating, in particular, the attachment area for the prongs depicted in FIGS. 4A-4F, wherein the location of the area of attachment can be anywhere along the side of the electrical device, according to an embodiment of the technology described herein;

FIG. 6A is a front view of a snap-on, one-piece cover plate having a single prong for a center hole attachment area, according to an embodiment of the technology described herein;

FIG. 6B is a rear view of the cover plate depicted in FIG. 6A;

FIG. 6C is a side cross-sectional view of the cover plate depicted in FIG. 6B;

FIG. 6D is a top view of the cover plate depicted in FIG. 6A, wherein the shape and size of the prong is not limited to that which is depicted but can vary according to the electrical device to which it is attached;

FIG. 7 is a rear perspective view of the cover plate depicted in FIG. 6A-6D;

FIG. 8A is a perspective view of a snap-on, one-piece cover plate having a single prong for an attachment area in a single hole of an electrical outlet, wherein the attachment area of this hole can apply to any electrical device that has a single hole similar to that depicted in FIG. 9, other types of light switches, or other types of electrical devices, according to an embodiment of the technology described herein;

FIG. 8B is a close-up view of the prong depicted in FIG. 8A;

FIG. 8C is an end view of the cover plate depicted in FIG. 8A;

FIG. 8D is a close-up view of the prong depicted in FIG. 8C;

FIG. 9 is a perspective view of an electrical outlet, illustrating, in particular, the attachment area for the prongs depicted in FIGS. 6A-8D, according to an embodiment of the technology described herein; and

FIG. 10A is a perspective view of a snap-on, one-piece cover plate having prongs for attachment areas in two holes of an electrical outlet, wherein the attachment areas of these two holes can apply to any electrical device that has two holes similar to those depicted in FIG. 11, for example, or other types of electrical devices, according to an embodiment of the technology described herein;

FIG. 10B is a close-up view of the prongs depicted in FIG. 10A;

FIG. 11 is a perspective view of an electrical outlet illustrating, in particular, the attachment areas for the two prongs as depicted, but not limited to, in FIGS. 10, 12, and 13;

FIG. 12A is a front view of another embodiment of a snap-on, one-piece cover plate, having prongs for attachment areas in two holes of an electrical outlet, wherein the attachment areas of these two holes can apply to any electrical device that has two holes similar to those depicted in FIG. 11, for example, or other types of electrical devices, according to an embodiment of the technology described herein;

FIG. 12B is a side cross-sectional view of the cover plate depicted in FIG. 12C;

FIG. 12C is a rear view of the cover plate depicted in FIG. 12A;

FIG. 12D is a top cross sectional view of the cover plate depicted in FIG. 12C, wherein the shape of the prong is not limited to the shape or size shown, but can vary according to need;

FIG. 13A is a perspective view of a snap-on, one-piece cover plate having prongs for a light switch attachment area, or other similarly shaped electrical device, according to an embodiment of the technology described herein;

FIG. 13B is a close up view of the prong for the cover plate depicted in FIG. 13A, wherein the shape of the prong is not limited to the shape or size shown, but can vary according to need;

FIG. 14A is a front view of a snap-on, one-piece cover plate having prongs for a light switch attachment area, or other similarly shaped electrical device, according to an embodiment of the technology described herein;

FIG. 14B is a rear view of the cover plate depicted in FIG. 14A;

FIG. 14C is a side view of the cover plate depicted in FIG. 14B;

FIG. 14D is a top view of the cover plate depicted in FIG. 14A;

FIG. 14E is a top, cross-sectional view of the cover plate depicted in FIG. 14B, wherein the shape of the prong is not limited to the shape or size shown, but can vary according to need, and wherein the distance between the prongs can vary according to the amount needed to attach the particular electrical device; and

FIG. 14F is a close-up view of a prong depicted in FIG. 14E, wherein the shape of the prong is not limited to the shape or size shown, but can vary according to need.

### DETAILED DESCRIPTION OF THE INVENTION

Before describing the disclosed embodiments of this technology in detail, it is to be understood that the technology is not limited in its application to the details of the particular arrangements shown here since the technology described is capable of other embodiments. Also, the terminology used herein is for the purpose of description and not of limitation.

In various exemplary embodiments, the technology described herein provides a snap-on, one-piece screwless cover plate to attach any electrical device to cover a receptacle box, such as, for example but not limited to, an electrical receptacle box for an electrical outlet.

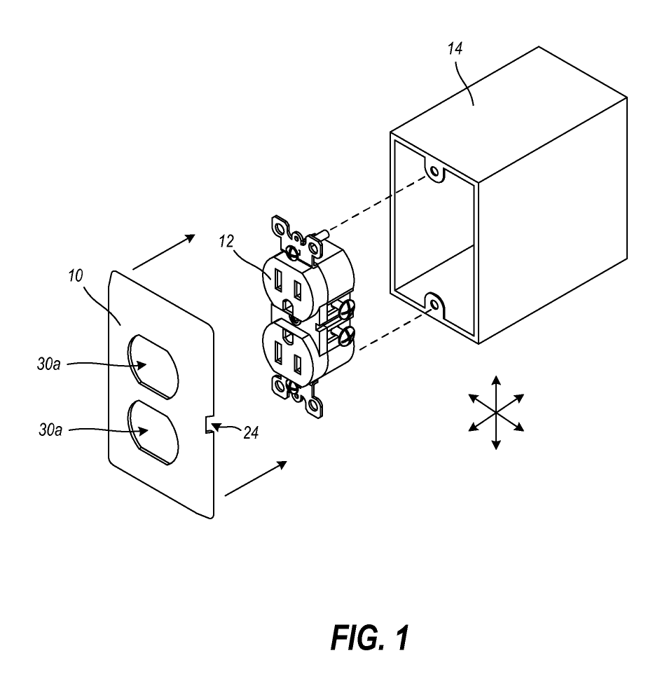

Referring now to FIG. 1, a snap-on, one-piece screwless cover plate 10 is shown in relation to an electrical device 12 and a receptacle box 14, illustrating, in particular, a method of installation upon a receptacle box 14. As shown, the snap-on, one-piece screwless cover plate 10 requires no screws, tools, or intervening device for installation. Thus, a cover plate 10 can be installed easily to the electrical device 12 without the need for installation screws, a screwdriver, or an intervening panel, or intervening device, for example. One method of installation, by way of example, includes: grasping the cover plate 10 and placing it over an electrical device 12 in a receptacle box 14 (both of which can be pre-existing in a wall, or the like, or distributed with the cover plate 10) and snapping the cover plate 10 directly into place, allowing the prongs to securely hold the cover plate 10 in place by attachment to the electrical device 12. No alteration to the pre-existing electrical device 12 and the receptacle box 14 is required. This method of covering a receptacle box 14 and the electrical device 12 attached to it with a snap-on, one-piece screwless cover plate 10 saves time, labor, and expense. The snap-on, one-piece screwless cover plate 10 can include at least one aperture for access to the electrical device 12. As shown, apertures 30a allow access to the receptacle outlets. In at least one embodiment, the snap-on, one-piece screwless cover plate 10 includes an optional slot(s) 24 for access and pop-off removal of the cover plate by a screwdriver or other similar tool or device.

Utilization of the snap-on, one-piece screwless cover plate 10 provides significant advantages over cover plates known in the art. Consider for example, that manually installing known cover plates for electrical receptacle boxes can be time consuming. It is cumbersome to have to install small screws to attach the cover plates to the electrical devices. An average house can contain over 100 wall mounted electrical devices (outlets, switches, etc.). The screws are usually in a small separate package which has to be opened. The installer then has to manipulate the tiny screws in his hands. The installer may drop them on the floor or other surface, have trouble finding them or may lose them. If the installer loses a screw or if some screws were missing from the package, the installer has to go get more screws. This costs time and money for the installer. The installer then has to insert the screws through the cover plate and line them up into tiny holes in the electrical device. A hand screwdriver, power screwdriver or other tool is then used to attach the screws through the cover plate into the electrical device. To manipulate the screws and the screwdrivers in your hand, while trying to get proper alignment of the screws for insertion into the electrical device, slows down the installation process. The screws for attachment not only slow the installation process down, but are usually contained in a separate package, are painted, can be chipped, or be the wrong color, can be missing from the package, or can get lost when dropped, all causing a longer installation time. Thus, utilization of the snap-on, one-piece screwless cover plate 10 provides significant advantages over cover plates known in the art.

As depicted in the remaining Figures, various prong configurations can be utilized. The prongs, located on the rear side of the cover plate 10, for example, are molded into, or otherwise integrally formed with, the cover plate 10. The prongs 16 are generally perpendicular or at a slight angle to the cover plate 10. This configuration enables the cover plate 10 to snap into, onto, or around an electrical device, such as 12, that is attached to the receptacle box 14, for example. The location of the prongs on the cover plate 10 will vary according to which electrical device is connected to the receptacle box 14. With any electrical device, the locations, shape, and size of the prongs are not limited only to those shown in the accompanying Figures.

The prongs 16 utilize a friction fit, a hooking type of fit, or snap into an existing hole(s) to enable the cover plate 10 to snap onto the electrical device 12. The prongs 16 can snap into, onto, or around whatever electrical device is used. Examples of prong locations, shapes and sizes of prongs, attachment areas, and electrical devices include, but are not limited to, those depicted in the Figures.

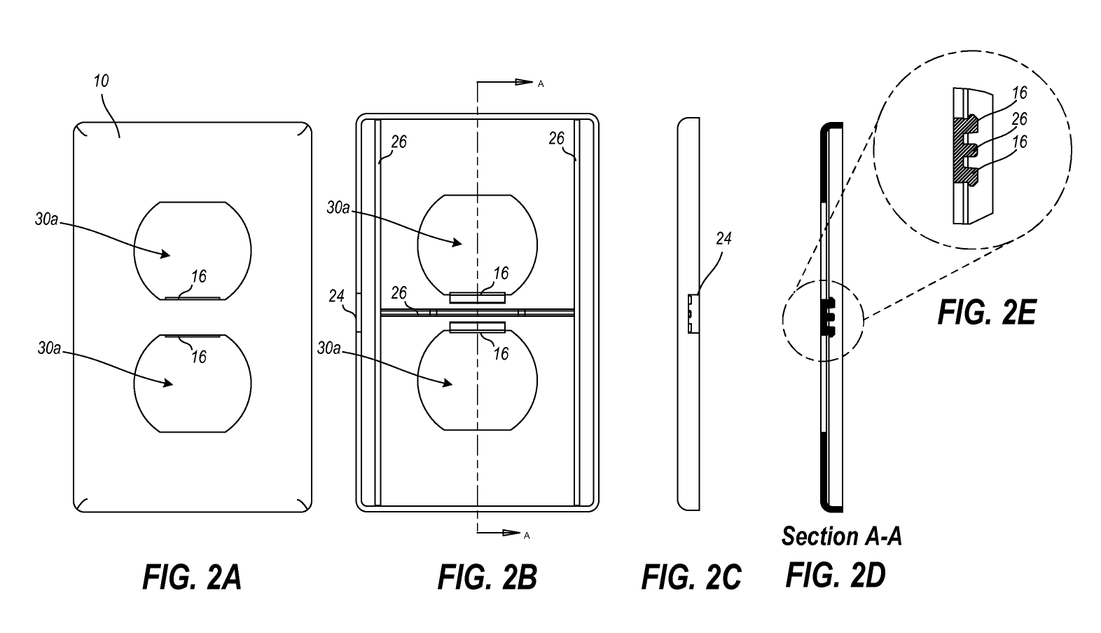

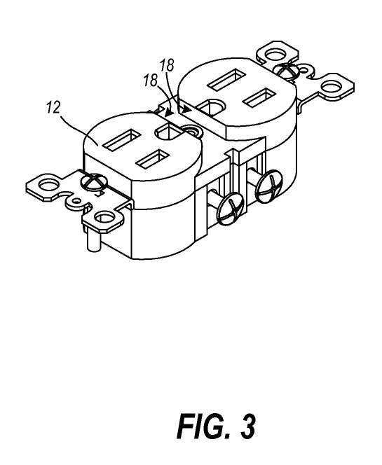

As depicted specifically in FIGS. 2A-2E and 3, a cover plate 10 having a pair of prongs 16 for a center attachment area 18 (illustrated on FIG. 3) on electrical device 12 is shown. A friction fit is formed when the prongs 16 are placed directly adjacent to the attachment areas 18 on the two plugs that make up the electrical device 12. The prongs 16 in this embodiment provide an outward tension that pushes against the center attachment areas 18 to hold the cover plate 10 securely in place. The cover plate 10 can include an optional slot 24 for ease in removal of the cover plate 10. The slot 24 provides a grip means by which the cover plate 10 can be pulled and removed with or without the use of a screwdriver or other tool. The location of the slot 24 on any of the embodiments can be on either side or the top or bottom of the cover plate 10, can be on one, two, three, or four sides, or can be omitted altogether. The size of slot 24 can vary according to need.

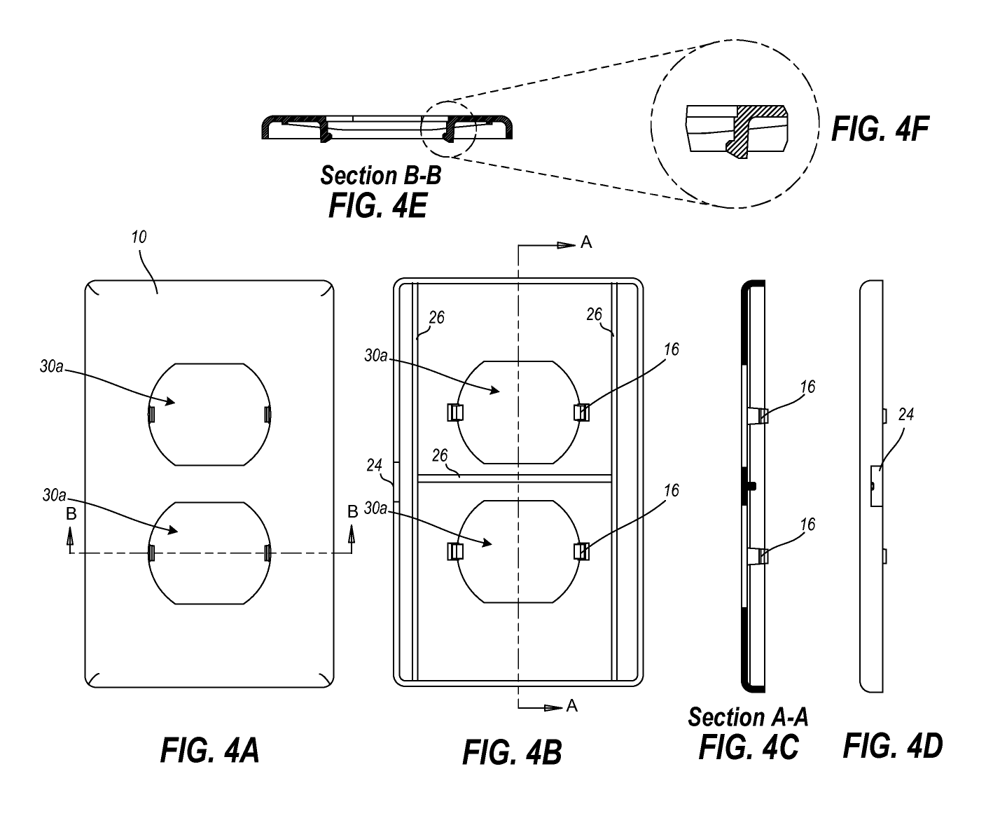

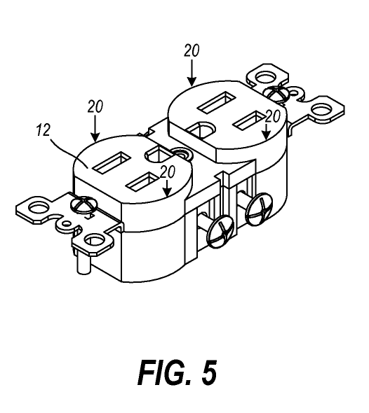

As depicted specifically in FIGS. 4A-4F and 5, a cover plate 10 having prongs 16 for a side attachment area 20 (illustrated on FIG. 5) on electrical device 12 is shown. A friction fit or snap fit is formed when the prongs 16 snap around the outside portions of the plugs of the electrical device 12, anywhere along the sides of the attachment areas 20, wherein the number of prongs can vary according to need. The prongs 16 in this embodiment provide an inward tension that pushes against the side attachment areas 20 on the sides of each plug to hold the cover plate 10 securely in place. The cover plate 10 can include one or more slot(s) 24 for ease in removal of the cover plate 10, if so desired.

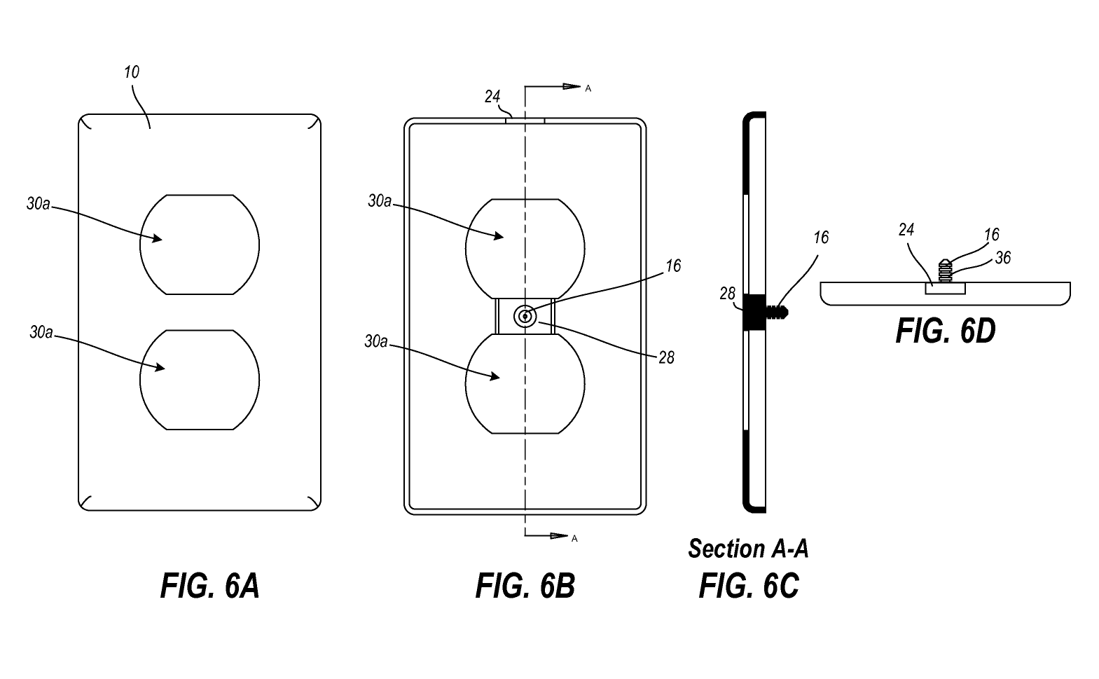

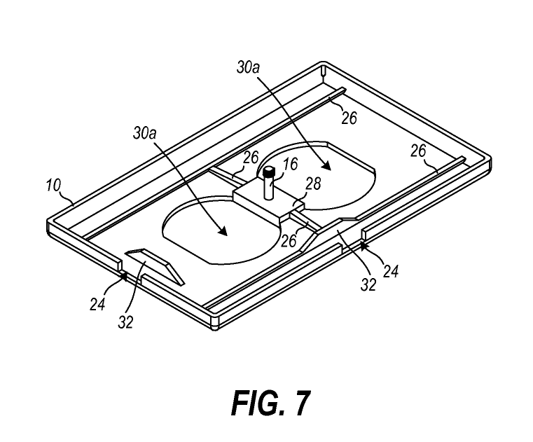

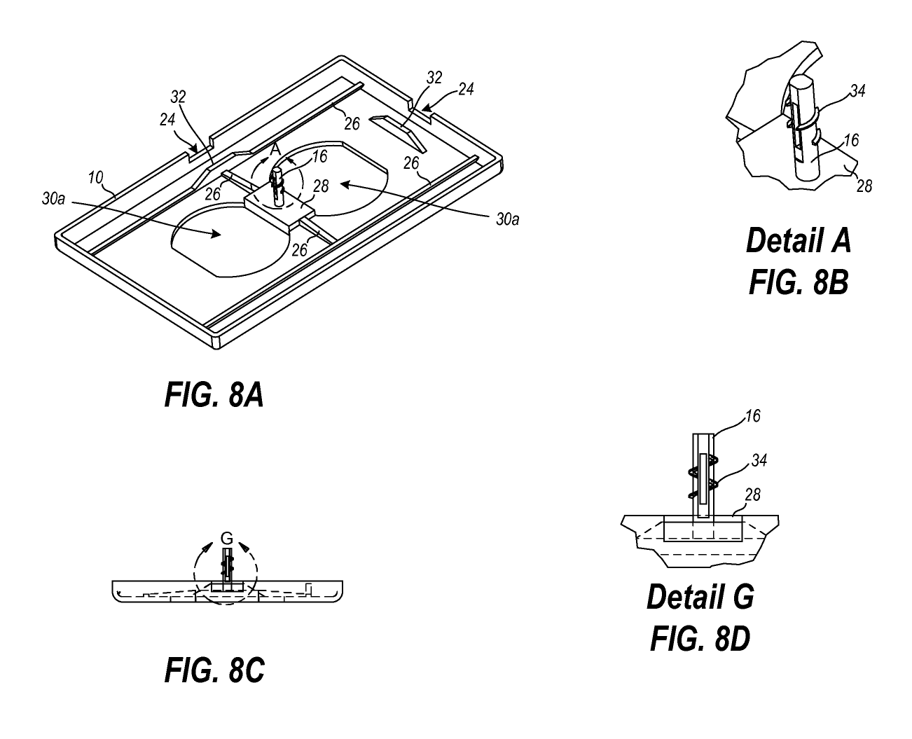

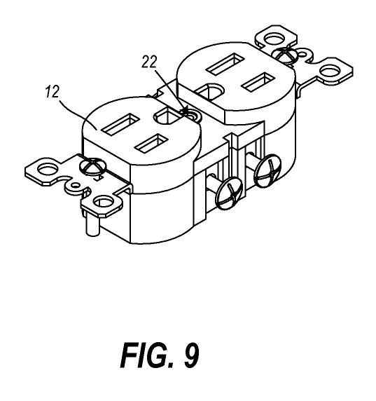

As depicted specifically in FIGS. 6A-6D, 7, 8A-8D, and 9, a cover plate 10 having a single prong 16 for a center hole attachment area 22 on electrical device 12 is shown. A friction fit or snap fit is formed when single prong 16 is placed in center hole attachment area 22 of the electrical device 12. The single prong 16 in this embodiment provides a tension in the center hole, or the like, of an electrical outlet. The cover plate 10 can include one or more slots 24 for ease in removal of the cover plate 10, if so desired. The cover plate 10 also can include one or more safety stops 32, if so desired, to prevent a screwdriver or other devices from penetrating into the area through slot 24, where an electrical shock could occur when contact is made with certain areas of the electrical device. As depicted in FIGS. 6B, 6C, 7, 8A-8D, 10A, 12C, and 13A, the reinforcing platform 28 can be a variety of shapes and sizes to accommodate the particular prong and electrical device into which the prong will be inserted. As depicted specifically in FIGS. 6B, 6C, 6D, 7, and 8A-8C, the single prong 16 can vary in shape and size depending on the specific application. By way of example, the shape of the prong can include threads 36 or fins 34.

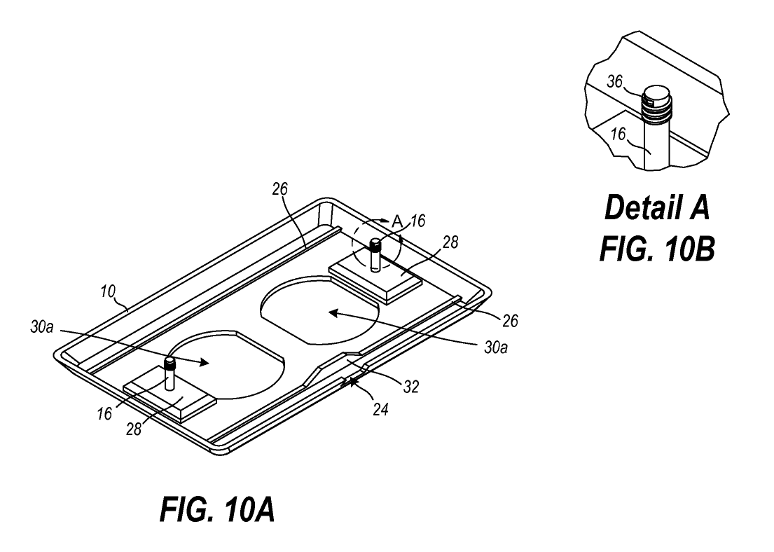

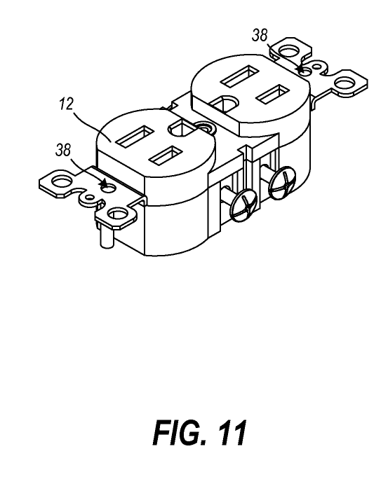

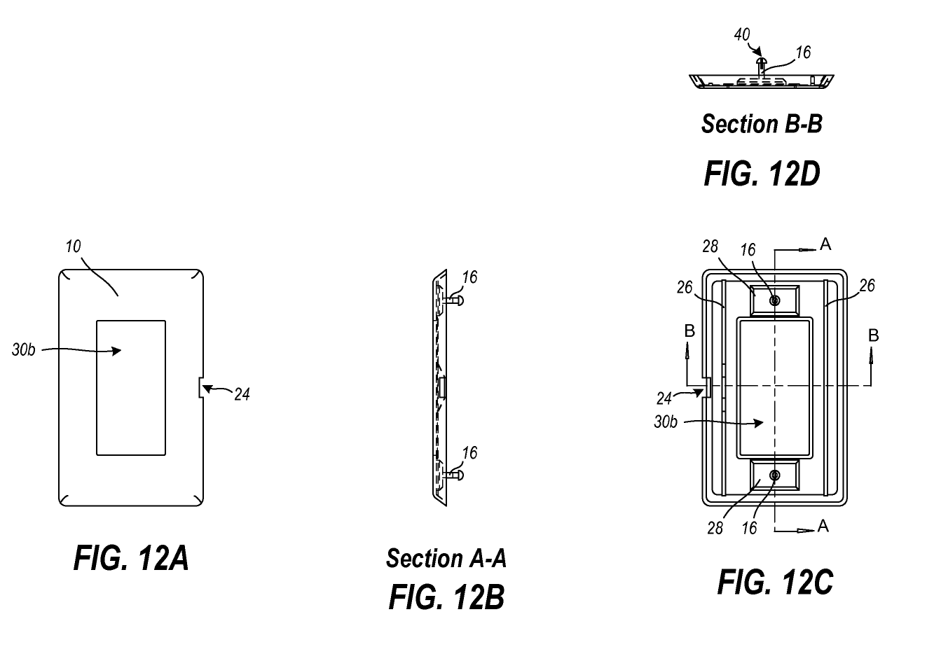

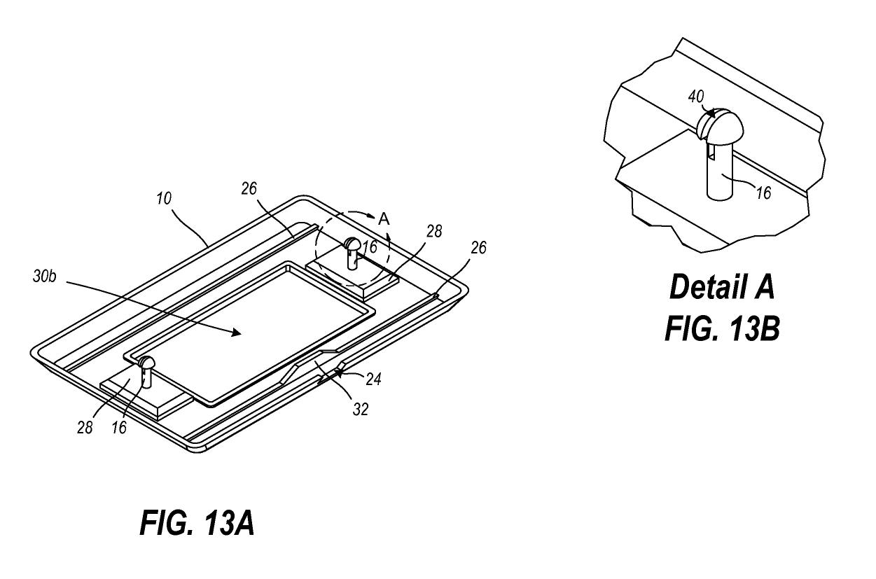

In at least one embodiment (FIGS. 10A-10B, 11, 12A-12D, and 13A-13B), the snap-on, one-piece screwless cover plate 10 includes prongs disposed on the cover plate 10 in a manner in which the cover plate 10 is secured to the electrical device 12 in an attachment area going into two existing holes 38 of the electrical device 12, one located above and one located below the electrical device, as shown in FIG. 11. As depicted specifically in FIGS. 10A-10B, 12B-12D, and 13A-13B, the shape of the prongs can vary depending on the specific application. By way of example, the shape of the prongs can include threads 36 or slot 40. The shape of the opening 30b (in FIGS. 12A-12D and 13A-13B) can vary according to the electrical device to which it is attached. In this embodiment, the opening 30b can accommodate a larger switch such as a light switch, dimmer switch, or the like.

As depicted specifically in FIGS. 12D, 13A-13B, a cover plate 10 having prongs 16 for a light switch attachment area, or the like, is shown. In this embodiment, the prongs 16 include a channel 40. The channel 40 aids in providing a tension to the device. As the cover plate 10 is inserted, the prongs are able to be depressed slightly to enter holes 38. This provides additional tension to secure the cover plate 10 to the electrical device 12 to which it is attached.

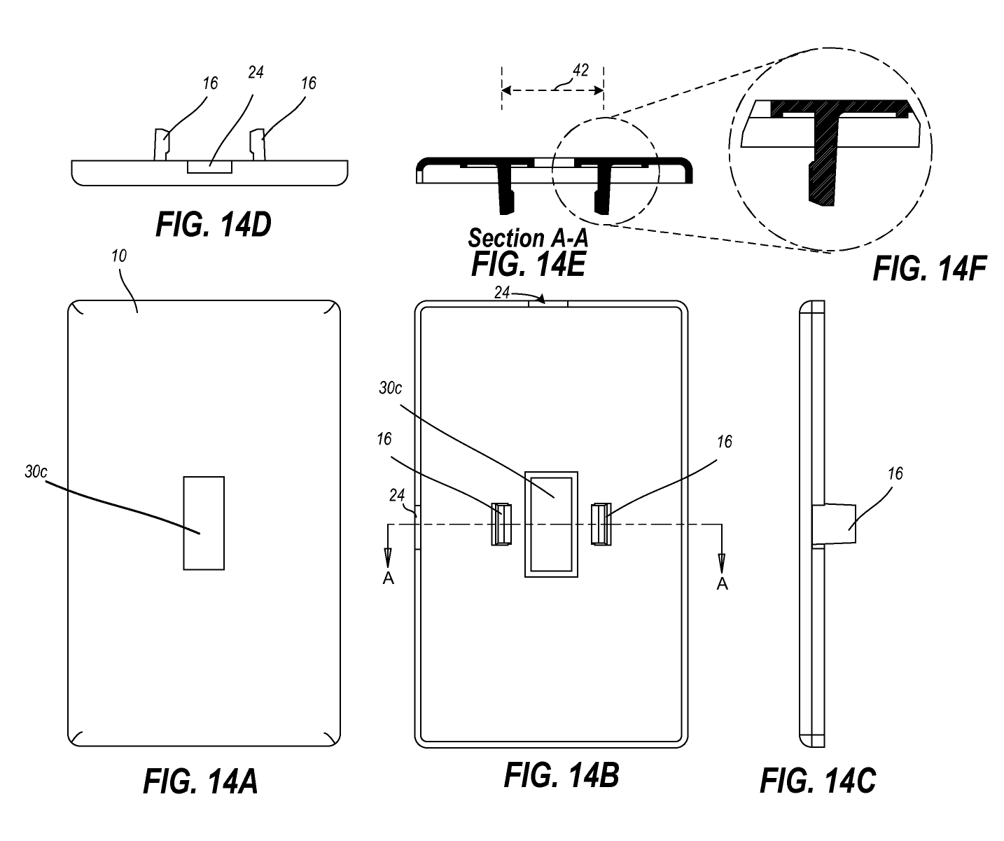

As depicted specifically in FIGS. 14A-14F, a cover plate 10 for a light switch, or the like, is shown. A friction fit or snap fit is formed when prongs 16 are attached to the side of the electrical light switch in the receptacle box 14. The width of the space between the prongs, as depicted by reference numeral 42, can vary according to the type of light switch or electrical device to which it is attached. The locations of the prongs 16 can be duplicated and adjusted for 1-gang, 2-gang, etc. configurations. The shape of the opening 30c between prongs 16 can vary according to the type of device to which the cover plate 10 is attached. By way of example, the shape of the opening 30c can be rectangular, round, etc., according to the electrical device to which it is attached.

As will be apparent to one of ordinary skill in the art, after reading the disclosure contained herein, there are numerous optional configurations of the locations of the prongs 16 and the shape, size, and configuration of the prongs 16, as well as openings 30a-30c, which can provide further options to accommodate various devices.

Although this technology has been illustrated and described herein with reference to preferred embodiments and specific examples thereof, it will be readily apparent to those of ordinary skill in the art that other embodiments and examples can perform similar functions and/or achieve like results. All such equivalent embodiments and examples are within the spirit and scope of the invention and are intended to be covered by the following claims.

What is claimed is:

1. A snap-on, one-piece screwless cover plate comprising:
at least one prong integrally formed upon a rear surface of the cover plate and adapted for coupling to at least one preexisting receiving area of a preexisting electrical device to secure the cover plate to the preexisting electrical device with a snap, friction fit;
wherein the cover plate does not require a screw to attach the cover plate to the preexisting electrical device;
wherein the cover plate does not require modification of the preexisting electrical device in order to be received and attached to the preexisting electrical device; and
wherein the cover plate does not require an intervening device in order to be received and attach to the preexisting electrical device.

2. The snap-on, one-piece screwless cover plate of claim 1, further comprising:
at least one pass-through opening disposed within the cover plate and adapted for the receipt of a portion of the preexisting electrical device for access to and control of the preexisting electrical device from an exterior side of the cover plate.

3. The snap-on, one-piece screwless cover plate of claim 1, wherein the at least prong further comprises a channel adapted to compress and expand as the at least one prong is inserted into the at least one preexisting receiving aperture of the preexisting electrical device.

4. The snap-on, one-piece screwless cover plate of claim 1, wherein the at least one prong further comprises a plurality of threads adapted to provide tension between the at least one prong and the at least one preexisting receiving aperture to secure the cover plate to the preexisting electrical device.

5. The snap-on, one-piece screwless cover plate of claim 1, wherein the at least one prong further comprises a plurality of fins adapted to provide tension between the at least one prong and the at least one preexisting receiving aperture to secure the cover plate to the preexisting electrical device.

6. The snap-on, one-piece screwless cover plate of claim 1, wherein the at least one prong further comprises a pair of prongs adapted for attachment to a center attachment area of an electrical device, wherein the center attachment area comprises a first surface of a base of an upper portion of the electrical device and a second surface of a top of a lower portion of the electrical device, and wherein the pair of prongs secures the cover plate by attachment to the first surface and the second surface with a snap, friction fit.

7. The snap-on, one-piece screwless cover plate of claim 1, wherein the at least one prong further comprises a plurality of prongs adapted for attachment to a plurality of side attachment areas of an electrical device, wherein the side attachment areas each comprise first and second side surfaces of an upper portion of the electrical device and third and fourth surfaces of a lower portion of the electrical device.

8. The snap-on, one-piece screwless cover plate of claim 1, wherein the at least one prong further comprises a single prong adapted for attachment to a single center hole attachment area in a preexisting electrical device, and wherein the cover plate is secured to the preexisting electrical device by a snap, friction fit to the single center hold attachment area.

9. The snap-on, one-piece screwless cover plate of claim 1, wherein the at least one prong further comprises a pair of prongs adapted for attachment to an upper hole and a lower hole in the preexisting electrical device, and wherein the cover plate is secured to the preexisting electrical device by a snap, friction fit to the upper hole and the lower hole.

10. The snap-on, one-piece screwless cover plate of claim 1, further comprising:
at least one removal slot disposed upon an outer edge of the cover plate and adapted to facilitate the removal of the cover plate from the preexisting electrical device.

11. The snap-on, one-piece screwless cover plate of claim 10, further comprising:
a safety stop disposed on the rear surface of the cover plate proximate to the removal slot, such that any item entering the removal slot is barred from an entry beyond a predetermined distance to avoid contact with a live electrical circuit.

12. The snap-on, one-piece screwless cover plate of claim 1, further comprising:
at least one support rib integrally formed upon a rear surface of the cover plate and adapted to provide additional structural integrity to the cover plate.

13. A cover plate assembly comprising:
a snap-on, one-piece screwless cover plate having at least one prong integrally formed upon a rear surface of the cover plate and adapted for coupling to at least one preexisting receiving area of a preexisting electrical device to secure the cover plate to the preexisting electrical device with a snap, friction fit;
an electrical device adapted to couple to the cover plate;
wherein the cover plate does not require a screw to attach the cover plate to the preexisting electrical device;
wherein the cover plate does not require modification of the preexisting electrical device in order to be received and attached to the preexisting electrical device; and
wherein the cover plate does not require an intervening device in order to be received and attach to the preexisting electrical device.

14. The cover plate assembly of claim 13, wherein the cover plate further comprises at least one pass-through opening disposed within the cover plate and adapted for the receipt of a portion of the preexisting electrical device for access to and control of the preexisting electrical device from an exterior side of the cover plate

15. The cover plate assembly of claim 13, further comprising:
a receptacle box adapted for receipt of the electrical device and adapted to be covered by the cover plate.

16. The cover plate assembly of claim 13, further comprising:
at least one removal slot disposed upon an outer edge of the cover plate and adapted to facilitate the removal of the cover plate from the preexisting electrical device.

17. The cover plate assembly of claim 16, further comprising:
a safety stop disposed on the rear surface of the cover plate proximate to the removal slot, such that any item entering the removal slot is barred from an entry beyond a predetermined distance to avoid contact with a live electrical circuit.

18. The cover plate assembly of claim 13, wherein the cover plate further comprises at least one support rib integrally formed upon a rear surface of the cover plate and adapted to provide additional structural integrity to the cover plate.
